(19) United States
(12) Patent Application Publication
(10) Pub. No.: US 2006/0114269 A1
(43) Pub. Date: Jun. 1, 2006

(54) Driving apparatus for overcoming color dispersion on display

(75) Inventors: Liou Chang-Ho, Shetou Shiang (TW); Chang Bou-Chi, Hsinchu City (TW); Huang Hsin-Mao, Alian Shiang (TW)

Correspondence Address: BRUCE H. TROXELL, SUITE 1404, 5205 LEESBURG PIKE, FALLS CHURCH, VA, 22041, US

(73) Assignee: Industrial Technology Research Institute

(21) Appl. No.: 11/106,578

(22) Filed: Apr. 15, 2005

(30) Foreign Application Priority Data
Nov. 26, 2004 (TW) 093136401

(51) Int. Cl. G09G 5/10

(52) U.S. Cl. 345/690

(57) ABSTRACT

The present invention discloses a driving apparatus for a display, capable of providing a respective driving voltage/current for each of three primary colors so as to overcome color dispersion on the display. The driving apparatus comprises a converting device for receiving a digital data representing a first driving voltage; wherein said converting device converts said digital data into a second driving voltage, a third driving voltage and a fourth driving voltage according to a transfer function, and then outputs said second driving voltage, said third driving voltage and said fourth driving voltage into a red-pixel source driving device, a green-pixel source driving device and a blue-pixel source driving device, respectively.

### BACKGROUND OF THE INVENTION

The present invention generally relates to a driving apparatus for a display and, more particularly, to a driving apparatus capable of providing a respective driving voltage/current for each of the three primary colors so as to overcome color dispersion on the display.

### FIELD OF THE INVENTION

To date, in a voltage-driven active matrix display, there is provided a single driving voltage for a common source driving device for the three primary colors, i.e., red, green and blue. However, each of the red, green and blue pixels exhibits different responses to the driving voltage. The prior art source driving device may cause some problems.

Please refer to FIG. 1, which shows the relations of analog voltage and brightness of a monochromic color versus operation voltage, respectively, for the conventional pixel source driving device in the prior art. In general, digital data by digital coding is used to represent the analog driving voltage provided for a pixel source driving device prior to being output to the pixel source driving device. The digital data is converted by a digital-to-analog converter (DAC) into an analog driving voltage required by the pixel source driving device. Therefore, the analog voltage value for the driving voltage is proportional to the digital coding for the driving voltage. Moreover, the pixel source driving device receiving the driving voltage exhibits a curved relation between the pixel brightness and the digital coding for the driving voltage.

Please also refer to FIG. 2, which shows the relations of analog voltage and brightness of three primary colors versus operation voltage, respectively, for the conventional pixel source driving device in the prior art. When the pixel source driving devices for three primary colors receive a single operation voltage, they exhibit different curves representing the relations between brightness and voltage. In other words, under the same operation voltage, the red (R) pixels, and green (G) pixels and the green (G) pixels exhibit different curves representing brightness, thus resulting in color dispersion on the display.

Therefore, there is need in providing a driving apparatus capable of providing a respective driving voltage/current for each of the three primary colors so as to overcome color dispersion on the display.

### SUMMARY OF THE INVENTION

It is the primary object of the present invention to provide a driving apparatus capable of providing a respective driving voltage/current for each of the three primary colors so as to overcome color dispersion on the display.

In order to achieve the foregoing objects, the present invention provides a driving apparatus for overcoming color dispersion on a display, comprising: a converting device for receiving a digital data representing a first driving voltage; wherein the converting device converts the digital data into a second driving voltage, a third driving voltage and a fourth driving voltage according to a transfer function, and then outputs the second driving voltage, the third driving voltage and the fourth driving voltage into a red-pixel source driving device, a green-pixel source driving device and a blue-pixel source driving device, respectively.

In the preferred embodiment of the present invention, the transfer function is expressed as
Vr=Kr×Vdata
Vg=Kg×Vdata
Vb=Kb×Vdata
where Vdata represents the digital data, (Kr, Kg, Kb) represents the transfer function, Vr represents the second driving voltage, Vg represents the third driving voltage, and Vb represents the fourth driving voltage.

The present invention further provides a driving apparatus for overcoming color dispersion on a display, comprising: a converting device for receiving a digital data representing a first driving current; wherein the converting device converts the digital data into a second driving current, a third driving current and a fourth driving current according to a transfer function, and then outputs the second driving current, the third driving current and the fourth driving current into a red-pixel source driving device, a green-pixel source driving device and a blue-pixel source driving device, respectively.

In the preferred embodiment of the present invention, the transfer function is expressed as
Ir=Kr×Idata
Ig=Kg×Idata
Ib=Kb×Idata
where Idata represents the digital data, (Kr, Kg, Kb) represents the transfer function, Ir represents the second driving current, Ig represents the third driving current, and Ib represents the fourth driving current.

Other and further features, advantages and benefits of the invention will become apparent in the following description taken in conjunction with the following drawings. It is to be understood that the foregoing general description and following detailed description are exemplary and explanatory but are not to be restrictive of the invention. The accompanying drawings are incorporated in and constitute a part of this application and, together with the description, serve to explain the principles of the invention in general terms.

### BRIEF DESCRIPTION OF THE DRAWINGS

The objects, spirits and advantages of the preferred embodiment of the present invention will be readily understood by the accompanying drawings and detailed descriptions:

FIG. 1 shows the relations of analog voltage and brightness of a monochromic color versus operation voltage, respectively, for the conventional pixel source driving device in the prior art;

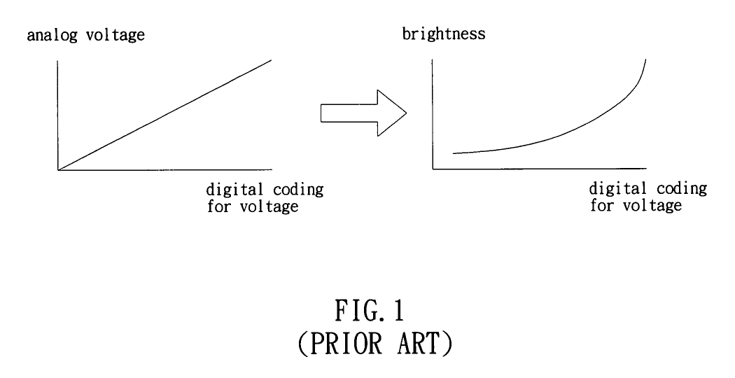

FIG. 2 shows the relations of analog voltage and brightness of three primary colors versus operation voltage, respectively, for the conventional pixel source driving device in the prior art;

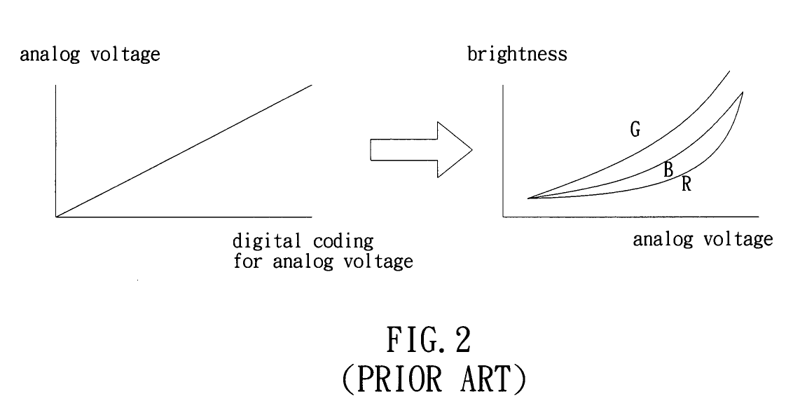

FIG. 3 shows the relations of analog voltage and brightness of three primary colors versus operation voltage, respectively, for a new pixel source driving device according to the present invention;

FIG. 4 is a schematic diagram showing a driving apparatus for overcoming color dispersion on a display according to one preferred embodiment of the present invention; and

FIG. 5 is a schematic diagram showing a driving apparatus for overcoming color dispersion on a display according to another embodiment of the present invention.

### DETAILED DESCRIPTION OF THE INVENTION

The present invention providing a driving apparatus capable of providing a respective driving voltage/current for each of the three primary colors so as to overcome color dispersion on the display can be exemplified by the preferred embodiments as described hereinafter.

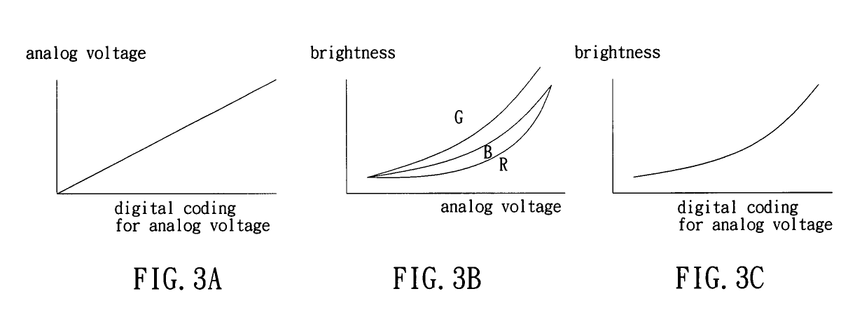

Please refer to FIG. 3, which shows the relations of analog voltage and brightness of three primary colors versus operation voltage, respectively, for a new pixel source driving device according to the present invention. In the present invention, there are provided respective operation voltages for each of the three primary colors. As shown in FIG. 3A, there are provided respective operation voltages for the respective source driving devices for the red pixels, the green pixels and the blue pixels. In other words, there are different curves for digital coding for the red pixels, the green pixels and the blue pixels.

As shown in FIG. 3C, in order for the three primary colors to have identical relation curves for brightness and digital coding for operation voltage, the operation voltages for the three primary colors have to be determined respectively according to the brightness-to-operation-voltage relation curves in FIG. 3B.

In order to provide respective operation voltages for the three primary colors, a plurality of voltage regulators and variable resistors are used at the inputs of the pixel source driving devices in the prior art. However, it increases layout complexity as well as consumed power because three sets of voltage regulators and variable resistors are required for three respective brightness-to-operation-voltage relation curves.

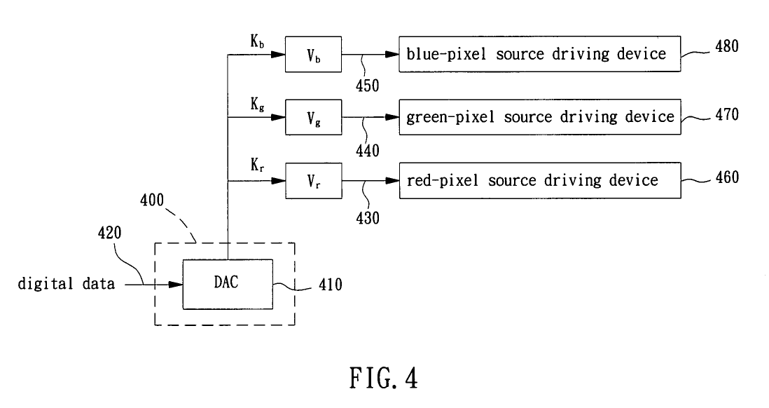

In the present invention, a common operation voltage is used as to overcome the foregoing problem. Please refer to FIG. 4, which is a schematic diagram showing a driving apparatus for overcoming color dispersion on a display according to one preferred embodiment of the present invention. In FIG. 4, the driving apparatus 400 comprises a digital-to-analog converter (DAC) 410. More particularly, the DAC 410 is embedded with a transfer function so as to convert received digital data 420 into respective analog signals.

The DAC 410 converts digital data 420 for the common operation voltage of the red-pixel source driving device 460, the green-pixel source driving device 470 and the green-pixel source driving device 480 into respective analog voltage signals 430, 440 and 450 for the red-pixel source driving device 460, the green-pixel source driving device 470 and the green-pixel source driving device 480 according to the transfer function.

More particularly, the transfer function is established according to the curved relations for operation voltage and brightness in FIG. 3 and is embedded in the DAC 410. The transfer function is expressed as
Vr=Kr×Vdata
Vg=Kg×Vdata
Vb=Kb×Vdata
where Vdata represents the digital data 420, (Kr, Kg, Kb) represents the transfer function, Vr represents the second driving voltage 430, Vg represents the third driving voltage 440, and Vb represents the fourth driving voltage 450.

More particularly,
Kr=(Rr/Rtotal) (1)
Kg=(Rg/Rtotal) (2)
Kb=(Rb/Rtotal) (3)
Rtotal=Rr+Rg+Rb
where Kr, Kg and Kb are implemented by using resistors.

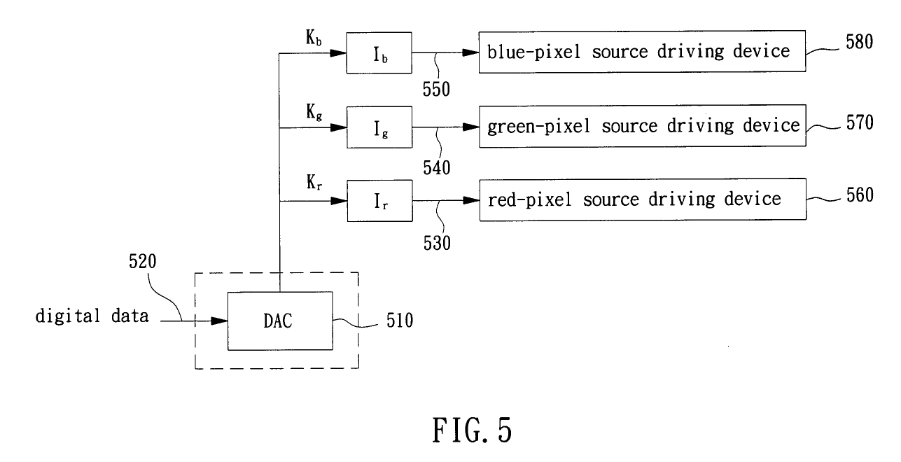

Please further refer to FIG. 5, which is a schematic diagram showing a driving apparatus for overcoming color dispersion on a display according to another embodiment of the present invention. Similarly, in FIG. 5, the driving apparatus 500 comprises a digital-to-analog converter (DAC) 510. More particularly, the DAC 510 is embedded with a transfer function so as to convert received digital data 520 into respective analog signals.

The DAC 510 converts digital data 520 for the common operation current of the red-pixel source driving device 460, the green-pixel source driving device 470 and the green-pixel source driving device 480 into respective analog current signals 530, 540 and 550 for the red-pixel source driving device 560, the green-pixel source driving device 570 and the green-pixel source driving device 580 according to the transfer function.

The transfer function is expressed as
Ir=Kr×Idata
Ig=Kg×Idata
Ib=Kb×Idata
where Idata represents the digital data 520, (Kr, Kg, Kb) represents the transfer function, Ir represents the second driving current 530, Vg represents the third driving current 540, and Vb represents the fourth driving current 550.

According to the above discussion, the present invention discloses a driving apparatus capable of providing a respective driving voltage/current for each of the three primary colors so as to overcome color dispersion on the display. Therefore, the present invention has been examined to be new, non-obvious and useful.

Although this invention has been disclosed and illustrated with reference to particular embodiments, the principles involved are susceptible for use in numerous other embodiments that will be apparent to persons skilled in the art. This invention is, therefore, to be limited only as indicated by the scope of the appended claims.

What is claimed is:

1. A driving apparatus for overcoming color dispersion on a display, comprising:
a converting device for receiving a digital data representing a first driving voltage;
wherein said converting device converts said digital data into a second driving voltage, a third driving voltage and a fourth driving voltage according to a transfer function, and then outputs said second driving voltage, said third driving voltage and said fourth driving voltage into a red-pixel source driving device, a green-pixel source driving device and a blue-pixel source driving device, respectively.

2. The driving apparatus as recited in claim 1, wherein said transfer function is a voltage-luminance relation.

3. The driving apparatus as recited in claim 2, wherein said transfer function is expressed as
Vr=Kr×Vdata
Vg=Kg×Vdata
Vb=Kb×Vdata
where Vdata represents said digital data, (Kr, Kg, Kb) represents said transfer function, Vr represents said second driving voltage, Vg represents said third driving voltage, and Vb represents said fourth driving voltage.

4. The driving apparatus as recited in claim 1, wherein said converting device is a digital-to-analog converter with said transfer function.

5. A driving apparatus for overcoming color dispersion on a display, comprising:
a converting device for receiving a digital data representing a first driving current;
wherein said converting device converts said digital data into a second driving current, a third driving current and a fourth driving current according to a transfer function, and then outputs said second driving current, said third driving current and said fourth driving current into a red-pixel source driving device, a green-pixel source driving device and a blue-pixel source driving device, respectively.

6. The driving apparatus as recited in claim 5, wherein said transfer function is a current-luminance relation.

7. The driving apparatus as recited in claim 6, wherein said transfer function is expressed as
Ir=Kr×Idata
Ig=Kg×Idata
Ib=Kb×Idata
where Idata represents said digital data, (Kr, Kg, Kb) represents said transfer function, Ir represents said second driving current, Ig represents said third driving current, and Ib represents said fourth driving current.

8. The driving apparatus as recited in claim 5, wherein said converting device is a digital-to-analog converter with said transfer function.
